(19) United States
(12) Patent Application Publication
(10) Pub. No.: US 2005/0105236 A1
(43) Pub. Date: May 19, 2005

(54) Power support unit for mobile electronic devices

(76) Inventor: David Van Leeuwen, Amityville, NY (US)

Correspondence Address: David Van Leeuwen, 73 Ireland Place #226, Amityville, NY, 11701, US

(21) Appl. No.: 10/707,054

(22) Filed: Nov. 18, 2003

(51) Int. Cl. H02H 9/06

(52) U.S. Cl. 361/118

(57) ABSTRACT

A power support unit between the vehicle power supply and an electronic device that maintains ample power to the electronic device should the vehicle's own demand become excessive in short term situations.

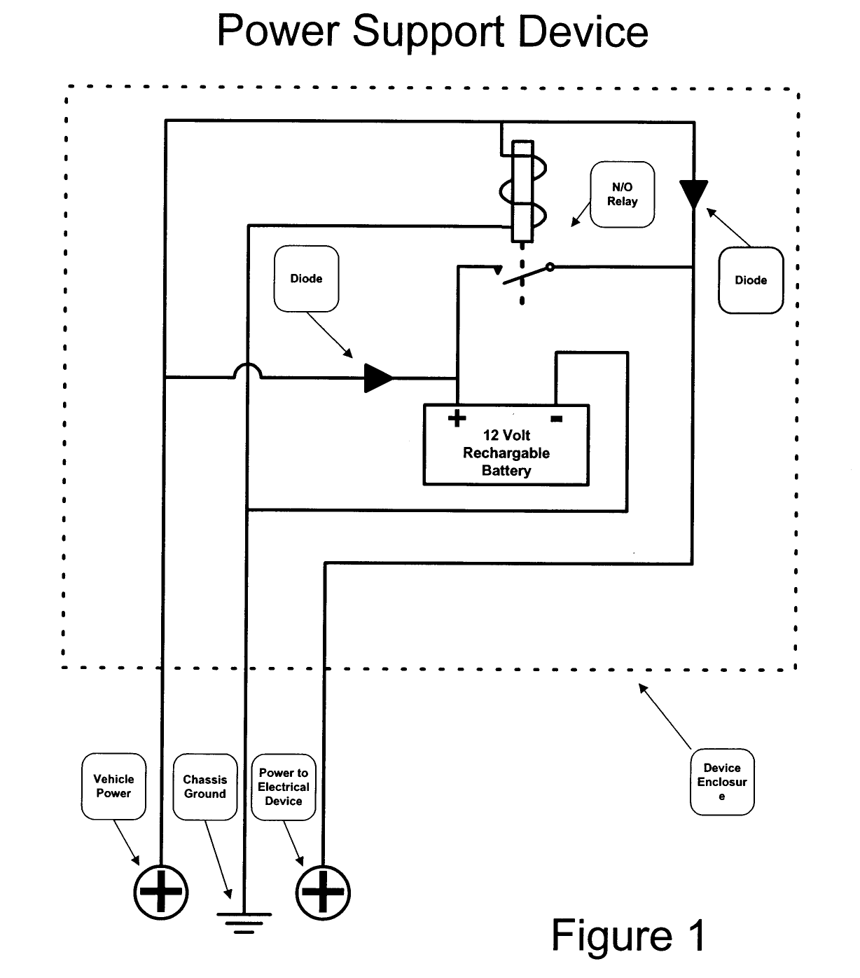

### DETAILED DESCRIPTION

The power unit is comprised of a PVC container, a 12-volt rechargeable battery, a SPST N/O relay, 2 diodes and wiring. Use of the unit between the vehicle power supply and the electronic device will maintain ample power to the electronic device should the vehicle's own demand become excessive in short term situations.

Heavy weight commercial vehicles are good examples of vehicles that may put demands on their electrical systems (lights, blowers, motors, etc) that can drop the power to very low levels. If an electronic device such as a computer is being supplied by that vehicle's power, it can cause many problems from lockup to burn up. By installing the power unit, vehicle power will be added to the battery power and sent to the electronic device. When vehicle power is turned off, battery disengages from system. In normal or low demand situations, the battery will be recharged.

Electronic device failure can cause from an annoyance to an extreme hazard; a very short power drop can lockup a computer. This unit will provide power only to the electronic device and maintain supply until high vehicle demand returns to normal. This unit will save the costs associated with lost time & failures from electronic device problems. This unit is not an uninterruptible power supply and will discontinue power when vehicle power is turned off.

1. A method to maintain adequate power to an electronic device powered by a supply experiencing temporary heavy demand by using power unit to supplement supply power, said power unit comprising: a PVC container, a 12-volt rechargeable battery, a SPST N/O relay, 2 diodes and wiring.

2. A method according to claim 1 wherein unit is conveniently located (top or side container connections) and wire run to connection point.

3. A method according to claim 1 wherein unit will maintain vehicle power supply in the event of a relay/battery or diode failure.

4. A method according to claim 1 wherein unit demand will be met by various battery sizes, unit battery will be easily replaceable.

5. A method according to claim 1 wherein unit demand will be met with surge protection available.
